(19) United States
(12) Patent Application Publication
(10) Pub. No.: US 2006/0018559 A1
(43) Pub. Date: Jan. 26, 2006

(54) Method and apparatus to transform/inverse transform and quantize/dequantize color image, and method and apparatus to encode/decode color image using it

(75) Inventors: Wooshik Kim, Yongin-si (KR); Hyun Mun Kim, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 11/186,817

(22) Filed: Jul. 22, 2005

Related U.S. Application Data
(60) Provisional application No. 60/589,846, filed on Jul. 22, 2004.

(30) Foreign Application Priority Data
Jul. 19, 2005 (KR) 10-2005-0065435

(51) Int. Cl. G06K 9/38

(52) U.S. Cl. 382/251

(57) ABSTRACT

A method and an apparatus for transforming/inverse transforming and quantizing/dequantizing a color image and a method and an apparatus for encoding/decoding a color image using the method and the apparatus. The method of transforming and quantizing the color image includes: transforming a color image into a frequency domain image; differently applying a transformation for removing a redundancy of direct current components of the frequency domain image depending on whether the color image is residual transformed and a macroblock estimation mode; and quantizing the frequency domain image from which the redundancy has been removed.

### CROSS-REFERENCE TO RELATED APPLICATIONS

This application claims the benefit of U.S. Provisional Patent Application No. 60/589,846, filed on Jul. 22, 2004, and Korean Patent Application No. 10-2005-0065435, filed on Jul. 19, 2005, in the Korean Intellectual Property Office, the disclosure of which is incorporated herein in its entirety by reference.

### BACKGROUND OF THE INVENTION

1. Field of the Invention

The present invention relates to encoding and decoding of a color image, and more particularly, to a method and an apparatus for transforming/inverse transforming and quantizing/dequantizing a residual transformed color image and a method and an apparatus for encoding/decoding the color image using the same.

2. Description of Related Art

In general, a color image is color transformed and then encoded. Various types of color coordinate systems are known. A standard coordinate system is an RGB coordinate system. An RGB image is transformed into an YCbCr image, divided into luminance and chrominance components, and encoded. As a result, since a redundancy of the chrominance components is removed by the transformation, encoding efficiency is increased. In particular, an integer transformation method using a lifting method has been studied. An example of this method is YCoCg-R developed by Microsoft Corporation.

When a transformed image is encoded, temporal and spatial estimations are performed to remove the redundancy of components so as to obtain a residual image.

In “Text of ISO/IEC FDIS 14496-10: Information Technology—Coding of audio-visual objects—Part 10: Advanced Video Coding”, ISO/IEC JTC 1/SC 29/WG 11, N5555, March, 2003 that is H.264/MPEG-4 pt. 10 AVC standard technology of Joint Video Team (JVT) of ISO/IEC MPEG and ITU-T VCEG, spatial and temporal estimation encoding is performed using various methods to improve encoding efficiency. However, when temporal and spatial estimations are performed with respect to chrominance components using the same method, a redundancy exists between residual images of chrominance components. To solve this, the residue images of the chrominance components are formed through the temporal and spatial estimations during encoding and transformation is performed with respect to the residue of the chrominance components so as to remove the redundancy of the residue of the chrominance components.

However, in this case, a residual transformation method cannot be used respect to intra 4×4 and 8×8 blocks. This is because the use of the residual transformation method cannot direct current (DC) transformation, thus it makes quantization inefficient. Thus, the residual transformation method is inefficient in terms of compression efficiency.

### BRIEF SUMMARY

An aspect of the present invention provides a method and an apparatus for quantizing and transforming a color image by which a residual transformation can be applied in any estimation mode to encode the color image.

An aspect of the present invention also provides a method and an apparatus for encoding a color image using the method and the apparatus for quantizing and transforming the color image.

Another aspect of the present invention also provides a method and an apparatus for dequantizing and inverse transforming a color image to decode a residual transformed color image in any estimation mode.

Another aspect of the present invention also provides a method and an apparatus for decoding a color image using the method and the apparatus for dequantizing and inverse transforming the color image.

According to an aspect of the present invention, there is provided a method of transforming and quantizing a color image, including: transforming a color image into a frequency domain image; differently applying a transformation for removing a redundancy of direct current components of the frequency domain image depending on whether the color image is residual transformed and a macroblock estimation mode; and quantizing the frequency domain image from which the redundancy has been removed.

The differently applying the transformation for removing the redundancy of the direct current components of the frequency domain image depending on whether the color image is residual transformed and the macroblock estimation mode may include: if information residual_colour_transform_flag as to whether a residual transformation is performed indicates a performance of the residual transformation residual_colour_transform_flag=1 and the macroblock estimation mode with respect to luma (Y or G component) is a 4×4 intra estimation mode Intra_{—}4×4 or a 8×8 intra estimation mode Intra_{—}8×8, quadruplicating a 4×4 direct current value matrix obtained from the result of the frequency transformation as in Equation below; and
fᵢⱼ=cᵢⱼ<<2 (where, i,j=0 . . . 3)
if the information residual_colour_transform_flag indicates a non-performance of the residual transformation residual_colour_transform_flag=0 or the macroblock estimation mode with respect to the luma (Y or G component) is not both the 4×4 intra estimation mode Intra_{—}4×4 and the 8×8 intra estimation mode Intra_{—}8×8, Hadamard-transforming the 4×4 direct current value matrix. Quantizing the frequency domain image from which the redundancy has been removed may include: if the information residual_colour_transform_flag indicates the performance of the residual transformation residual_colour_transform_flag=1, representing a quantization parameter of a chrominance component as in the Equation below:
QP′c=QPc+QpBdOffsetc
wherein QpBdOffsetc=6*(bit_depth_chroma_minus8+residual_colour_transform_flag) and QPc denotes a quantization parameter of a chrominance component Cb, Cr, R, or B, where QpBdOffsetc denotes offset of QPc and bit_depth_chroma_minus8 denotes a bit_depth of a chrominance array sample per pixel; if the information residual_colour_transform_flag indicates the non-performance of the residual transformation residual_colour_transform_flag=0, representing the quantization parameter of the chrominance component as in the Equation below:
QP′c=QPc+QpBdOffsetc
wherein QpBdOffsetc=6*bit_depth_chroma_minus8; and quantizing the transformed color image data using the QP′c.

According another aspect of the present invention, there is provided an apparatus for transforming and quantizing a color image, including: a domain transformer transforming a color image into a frequency domain image; a redundancy remover differently applying a transformation for removing a redundancy of direct current components of the frequency domain image depending on whether the color image is residual transformed and a macroblock estimation mode; and a quantizer quantizing the frequency domain image from which the redundancy has been removed.

The redundancy remover may include: if information residual_colour_transform_flag as to whether a residual transformation is performed indicates a performance of the residual transformation residual_colour_transform_flag=1 and the macroblock estimation mode with respect to luma (Y or G component) is a 4×4 intra estimation mode Intra_{—}4×4 or a 8×8 intra estimation mode Intra_{—}8×8, a direct current value transformer quadruplicating a 4×4 direct current value matrix obtained from the result of the frequency transformation as in the Equation below; and
fᵢⱼ=cᵢⱼ<<2 (where, i,j=0 . . . 3)
if the information residual_colour_transform_flag indicates a non-performance of the residual transformation residual_colour_transform_flag=0 or the macroblock estimation mode with respect to the luma (Y or G component) is not both the 4×4 intra estimation mode Intra_{—}4×4 and the 8×8 intra estimation mode Intra_{—}8×8, a Hadamard transformer Hadamard-transforming the 4×4 direct current value matrix. The quantizer may include: if the information residual_colour_transform_flag indicates the performance of the residual transformation residual_colour_transform_flag=1, a first quantization parameter transformer representing a quantization parameter of a chrominance component as in the Equation below:
QP′c=QPc+QpBdOffsetc
wherein QpBdOffsetc=6*(bit_depth_chroma_minus8+residual_colour_transform_flag) and QPc denotes a quantization parameter of a chrominance component Cb, Cr, R, or B, where QpBdOffsetc denotes offset of QPc and bit_depth_chroma_minus8 denotes a bit depth of a chrominance array sample per pixel; if the information residual_colour_transform_flag indicates the non-performance of the residual transformation residual_colour_transform_flag=0, a second quantization parameter transformer representing the quantization parameter of the chrominance component as in the Equation below:
QP′c=QPc+QpBdOffsetc
wherein QpBdOffsetc=6*bit_depth_chroma_minus8; and a color image quantizer quantizing the transformed color image data using the QP′c.

According to still another aspect of the present invention, there is provided a method of encoding a color image, including: temporally (inter) and spatially (intra) estimating an input color image; residual transforming the estimated color image; transforming the color image into a frequency domain image; differently applying a transformation for removing a redundancy of direct current components of the frequency domain image depending on whether the color image is residual transformed and an estimation mode; quantizing the frequency domain image from which the redundancy has been removed; and entropy encoding the quantized data.

According yet another aspect of the present invention, there is provided an apparatus for encoding a color image, including: an estimator temporally (inter) and spatially (intra) estimating an input color image; a residual transformer residual transforming the estimated color image; a domain transformer transforming the color image into a frequency domain image; a redundancy remover differently applying a transformation for removing a redundancy of direct current components of the frequency domain image depending on whether the color image is residual transformed and a macroblock estimation mode; a quantizer quantizing the frequency domain image from which the redundancy has been removed; and an entropy encoder entropy encoding the quantized data.

According to yet another aspect of the present invention, there is provided a method of dequantizing and inverse transforming a color image, including: differently setting a quantization parameter of a chrominance component depending on whether the color image is residual transformed to dequantize the quantized color image data; and differently performing a recovery of a redundancy of direct current components of the color image depending on whether the color image is residual transformed and an estimation mode to frequency inverse transform the dequantized data.

The dequantizing the quantized color image may include: if information residual_colour_transform_flag as to whether a residual transformation is performed indicates a performance of the residual transformation residual_colour_transform_flag=1, representing a quantization parameter of a chrominance component as in the Equation below:
QP′c=QPc+QpBdOffsetc
wherein QpBdOffsetc=6*(bit_depth_chroma_minus8+residual_colour_transform_flag) and QPc denotes a quantization parameter of a chrominance component Cb, Cr, R, or B, where QpBdOffsetc denotes offset of QPc and bit_depth_chroma_minus8 denotes a bit depth of a chrominance array sample per pixel; if the information residual_colour_transform_flag indicates a non-performance of the residual transformation residual_colour_transform_flag=0, representing the quantization parameter of the chrominance component as in the Equation below:
QP′c=QPc+QpBdOffsetc
wherein QpBdOffsetc=6*bit_depth_chroma_minus8; and dequantizing the transformed color image data using the QP′c.

The frequency inverse transforming the dequantized data may include: if the information residual_colour_transform_flag indicates the performance of the residual transformation residual_colour_transform_flag=1 and a macroblock estimation mode with respect to luma (Y or G component) is a 4×4 intra estimation mode Intra_{—}4×4 or a 8×8 intra estimation mode Intra_{—}8×8, quadruplicating a transformed 4×4 direct current value matrix obtained from entropy decoded color image data as in the Equation below;
fᵢⱼ=cᵢⱼ<<2 (where, i,j=0 . . . 3)
if the information residual_colour_transform_flag indicates the non-performance of the residual transformation residual_colour_transform_flag=0 or the macroblock estimation mode with respect to the luma (Y or G component) is not both the 4×4 intra estimation mode Intra_{—}4×4 and the 8×8 intra estimation mode Intra_{—}8×8, Hadamard inverse transforming the transformed 4×4 direct current value matrix; and frequency inverse transforming the result value of the quadruplication or the Hadamard inverse transformation and an alternating current value recovered from the entropy decoded color image. The frequency transformation may be an integer inverse transformation of H.264 or an IDCT of MPEG.

According to yet another aspect of the present invention, there is provided an apparatus for dequantizing and inverse transforming a color image, including: a dequantizer differently setting a quantization parameter of a chrominance component depending on whether quantized color image data is residual transformed to dequantize the quantized color image data; and a frequency inverse transformer differently performing a recovery of a redundancy of direct current components of a color image depending on whether the color image is residual transformed and an estimation mode to frequency inverse transform the dequantized data.

The dequantizer may include: if information residual_colour_transform_flag as to whether a residual transformation is performed indicates a performance of the residual transformation residual_colour_transform_flag=1, a first dequantization parameter transformer representing a quantization parameter of a chrominance component as in the Equation below:
QP′c=QPc+QpBdOffsetc
wherein QpBdOffsetc=6*(bit_depth chroma_minus8+residual_colour_transform_flag) and QPc denotes a quantization parameter of a chrominance component Cb, Cr, R, or B, where QpBdOffsetc denotes offset of QPc and bit_depth_chroma_minus8 denotes a bit depth of a chrominance array sample per pixel; if the information residual_colour_transform_flag indicates a non-performance of the residual transformation residual_colour_transform_flag=0, a second dequantization parameter transformer representing the quantization parameter of the chrominance component as in the Equation below:
QP′c=QPc+QpBdOffsetc
wherein QpBdOffsetc=6*bit_depth_chroma_minus8; and a color image dequantizer dequantizing the transformed color image data using the QP′c. The frequency inverse transformer may include: if the information residual_colour_transform_flag indicates the performance of the residual transformation residual_colour_transform_flag=1 and a macroblock estimation mode with respect to luma (Y or G component) is a 4×4 intra estimation mode Intra_{—}4×4 or a 8×8 intra estimation mode Intra_{—}8×8, a direct current value inverse transformer quadruplicating a transformed 4×4 direct current value matrix obtained from entropy decoded color image as in the Equation below;
fᵢⱼ=cᵢⱼ<<2 (where, i,j=0 . . . 3)
if the information residual_colour_transform_flag indicates the non-performance of the residual transformation residual_colour_transform_flag=0 or the macroblock estimation mode with respect to the luma (Y or G component) is not both the 4×4 intra estimation mode Intra_{—}4×4 and the 8×8 intra estimation mode Intra_{—}8×8, a Hadamard inverse transformer Hadamard inverse transforming the transformed 4×4 direct current value matrix; and a domain inverse transformer frequency inverse transforming the result value of the direct current value inverse transformer or the Hadamard inverse transformer and an alternating current value recovered from the entropy decoded color image. The frequency inverse transformation performed by the domain inverse transformer is an integer inverse transformation of H.264 or an IDCT of MPEG.

According to yet another aspect of the present invention, there is provided a method of decoding a color image, including: entropy decoding encoded color image data to recover quantized data; differently setting a quantization parameter of a chrominance component depending on whether the color image is residual transformed to dequantize the quantized data; differently performing a recovery of a redundancy of direct current components of the color image depending on whether the color image is residual transformed and an estimation mode to frequency inverse transform the dequantized data; residual inverse transforming the frequency inverse transformed data; and performing intra and inter estimation compensations with respect to the residual inverse transformed data.

According to yet another aspect of the present invention, there is provided an apparatus for decoding a color image, including: an entropy decoder entropy decoding encoded color image data to recover quantized data; a dequantizer differently setting a quantization parameter of a chrominance component depending on whether the color image is residual transformed to dequantize the quantized data; a frequency inverse transformer differently performing a recovery of a redundancy of direct current components of the color image depending on whether the color image is residual transformed and a macroblock estimation mode to frequency inverse transform the dequantized data; a residual inverse transformer residual inverse transforming the frequency inverse transformed data; and an estimation compensator performing intra and inter estimation compensations with respect to the residual inverse transformed data.

According to other aspects of the present invention, there are provided computer-readable storage media encoded with processing instructions for causing a process or to perform various methods according to the foregoing aspects of the present invention.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram of an apparatus for transforming and quantizing a color image according to an embodiment of the present invention;

FIG. 2 is a block diagram of a redundancy remover shown in FIG. 1;

FIG. 3 is a block diagram of a quantizer shown in FIG. 1;

FIG. 4 is a flowchart of a method of transforming and quantizing a color image according to an embodiment of the present invention;

FIG. 5 is a flowchart of operation 430 of the method of FIG. 4;

FIG. 6 is a flowchart of operation 460 of the method of FIG. 4;

FIG. 7 is a block diagram of an apparatus for encoding a color image using the apparatus for transforming and quantizing the color image according to an embodiment of the present invention;

FIG. 8 is a flowchart of a method of encoding a color image using the method of transforming and quantizing the color image according to an embodiment of the present invention;

FIG. 9 is a block diagram of an apparatus for dequantizing and inverse transforming a color image according to an embodiment of the present invention;

FIG. 10 is a block diagram of a dequantizer shown in FIG. 9;

FIG. 11 is a block diagram of an inverse transformer shown in FIG. 9;

FIG. 12 is a flowchart of a method of dequantizing and inverse transforming a color image according to an embodiment of the present invention;

FIG. 13 is a flowchart of a dequantization of the color image shown in FIG. 12;

FIG. 14 is a flowchart of an inverse transformation of the color image shown in FIG. 12;

FIG. 15 is a block diagram of an apparatus for decoding a color image using the apparatus for dequantizing and inverse transforming the color image according to an embodiment of the present invention; and

FIG. 16 is a flowchart of a method of decoding a color image using the method of dequantizing and inverse transforming the color image according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

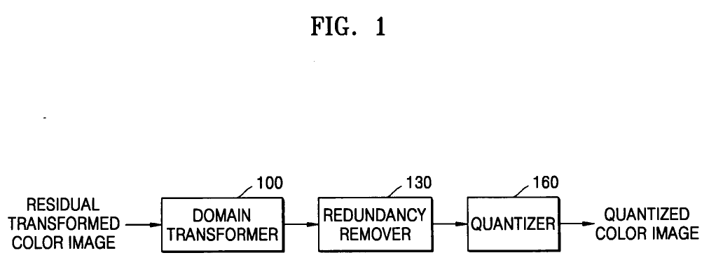

FIG. 1 is a block diagram of an apparatus for transforming and quantizing a color image according to an embodiment of the present invention. Referring to FIG. 1; the apparatus includes a domain transformer 100, a redundancy remover 130, and a quantizer 160.

The domain transformer 100 transforms a color image into a frequency domain image.

The redundancy remover 130 differently applies a transformation for removing a redundancy of DC components of the frequency domain image depending on whether the color image is residual transformed and a macroblock estimation mode.

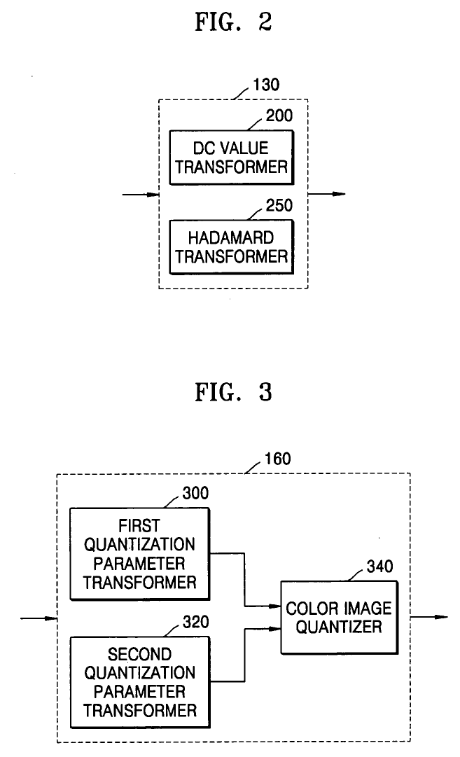

FIG. 2 is a block diagram of the redundancy remover 130 shown in FIG. 1. Referring to FIG. 2, the redundancy remover 130 includes a DC value transformer 200 and a Hadamard transformer 250. When information residual_colour_transform_flag as to whether a residual transformation is performed indicates a performance of the residual transformation residual_colour_transform_flag=1 and the macroblock estimation mode with respect to luma (Y or G component) is a 4×4 intra estimation mode Intra_{—}4×4 or a 8×8 intra estimation mode Intra_{—}8×8, the DC value transformer 200 quadruplicates a 4×4 DC value matrix obtained from the result of the frequency transformation as in Equation 1;
fᵢⱼ=cᵢⱼ<<2 (where, i,j=0 . . . 3) (1)

When the information residual_colour_transform_flag indicates a non-performance of the residual transformation residual_colour_transform_flag=0 or the macroblock estimation mode with respect to the luma (Y or G component) is not both the 4×4 intra estimation mode Intra_{—}4×4 and the 8×8 intra estimation mode Intra_{—}8×8, the Hadamard transformer 250 Hadamard-transforms the 4×4 DC value matrix as in Equation 2:

$$f = [ \begin{matrix}1 & 1 & 1 & 1 \\ 1 & 1 & - 1 & - 1 \\ 1 & - 1 & - 1 & 1 \\ 1 & 1 & 1 & - 1\end{matrix} ] [ \begin{matrix}{c}_{00} & {c}_{01} & {c}_{02} & {c}_{03} \\ {c}_{10} & {c}_{11} & {c}_{12} & {c}_{13} \\ {c}_{20} & {c}_{21} & {c}_{22} & {c}_{23} \\ {c}_{30} & {c}_{31} & {c}_{32} & {c}_{33}\end{matrix} ] [ \begin{matrix}1 & 1 & 1 & 1 \\ 1 & 1 & - 1 & - 1 \\ 1 & - 1 & - 1 & 1 \\ 1 & - 1 & 1 & - 1\end{matrix} ] \qquad ( 2 )$$

The quantizer 160 quantizes the frequency domain image from which the redundancy has been removed.

FIG. 3 is a block diagram of the quantizer 160 shown in FIG. 1. Referring to FIG. 3, the quantizer 160 includes a first quantization parameter transformer 300, a second quantization parameter transformer 320, and a color image quantizer 340. When the information residual_colour_transform_flag indicates the performance of the residual transformation residual_colour_transform_flag=1, the first quantizer parameter transformer 300 represents a quantization parameter of a chrominance component as in Equation 3:
QP′c=QPc+QpBdOffsetc (3)
wherein QpBdOffsetc=6*(bit_depth_chroma_minus8+residual_colour_transform_flag) and QPc denotes a quantization parameter of a chrominance component Cb, Cr, R, or B, where QpBdOffsetc denotes an offset of QPc and bit_depth_chroma_minus8 denotes a bit depth of a chrominance array sample per pixel.

When the information residual_colour_transform_flag indicates the non-performance of the residual transformation residual_colour_transform_flag=0, the second quantization parameter transformer 320 represents the quantization parameter of the chrominance component as in Equation 4:
QP′c=QPc+QpBdOffsetc (4)
wherein QpBdOffsetc=6*bit_depth_chroma_minus8.

The color image quantizer 340 quantizes the transformed color image data using the QP′c.

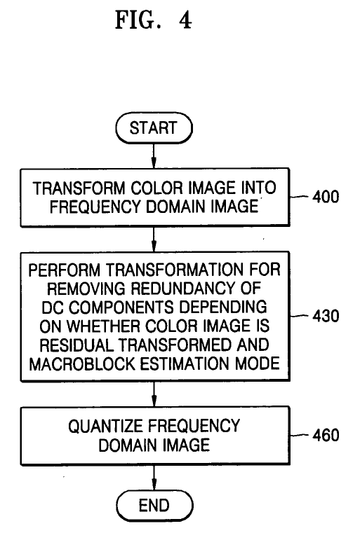

FIG. 4 is a flowchart of a method of transforming and quantizing a color image according to an embodiment of the present invention. A method and an apparatus for transforming and quantizing a color image according to an embodiment of the present invention will now be described with reference to FIGS. 3 and 4.

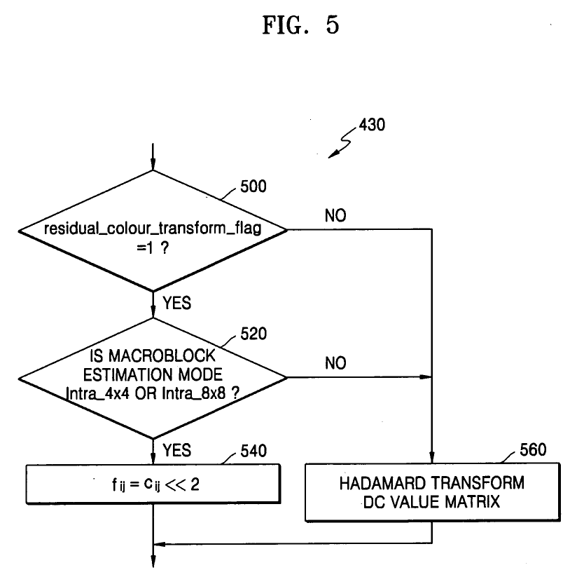

In operation 400, the domain transformer 100 transforms a color image into a frequency domain image. In operation 430, the redundancy remover 130 differently applies a transformation for removing a redundancy of DC components of the frequency domain image depending on whether the color image is residual transformed and a macroblock estimation mode. FIG. 5 is a flowchart of operation 430 of the method of FIG. 4. If information residual_colour_transform_flag as to whether a residual transformation is performed indicates a performance of the residual transformation residual_colour_transform_flag=1 in operation 500 and the macroblock estimation mode with respect to luma (Y or G component) is a 4×4 intra estimation mode Intra_{—}4×4 or a 8×8 intra estimation mode Intra_{—}8×8 in operation 520, the DC value transformer 200 quadruplicates a 4×4 DC value matrix obtained from the result of the frequency transformation as in Equation 1 above in operation 540.

If the information residual_colour_transform_flag indicates a non-performance of the residual transformation residual_colour_transform_flag=0 in operation 500 or the macroblock estimation mode with respect to the luma (Y or G component) is not both the 4×4 intra estimation mode Intra_{—}4×4 and the 8×8 intra estimation mode Intra_{—}8×8 in operation 520, the Hadamard transformer 250 Hadamard-transforms the 4×4 DC value matrix in operation 560.

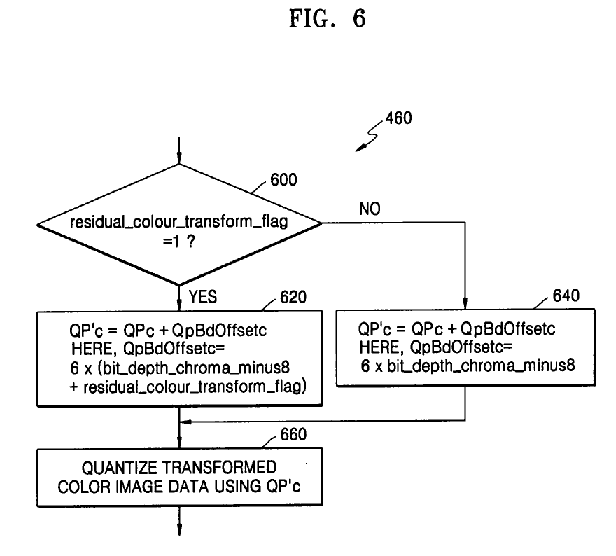

If the redundancy of the DC components is removed in operation 430, the quantizer 160 quantizes the frequency domain image from which the redundancy of the DC components has been removed, in operation 460. FIG. 6 is a flowchart of operation 460 of the method of FIG. 4. If the information residual_colour_transform_flag indicates the performance of the residual transformation residual_colour_transform_flag=1 in operation 600, the first quantization parameter transformer 300 represents a quantization parameter of a chrominance component as in Equation 3 above in operation 620. If the information residual_colour_transform_flag indicates the non-performance of the residual transformation residual_colour_transform_flag=0 in operation 600, the second quantization parameter transformer 320 represents the quantization parameter of the chrominance component as in Equation 4 above in operation 640. The color image quantizer 340 quantizes the transformed color image data using the QP′c in operation 660.

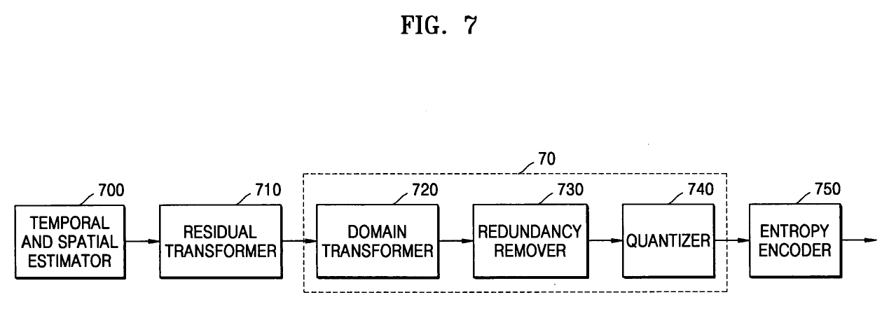

An apparatus and a method for encoding a color image using the apparatus and the method for transforming and quantizing the color image will now be described. FIG. 7 is a block diagram of an apparatus for encoding a color image using the apparatus for transforming and quantizing the color image. Referring to FIG. 7, the apparatus includes a temporal and spatial estimator 700, a residual transformer 710, a transformer and quantizer 70, and an entropy encoder 750. The temporal and spatial estimator 700 temporally (inter estimates) and spatially (intra estimates) an input color image. The residual transformer 710 residual transforms the estimated color image. The transformer and quantizer 70 is the same as the apparatus for transforming and quantizing the color image and includes a domain transformer 720, a redundancy remover 730, and a quantizer 740. The domain transformer 720 transforms the color image into a frequency domain image and is the same as the domain transformer 100 shown in FIG. 1. The redundancy remover 730 differently applies a transformation for removing a redundancy of DC components of the frequency domain image depending on whether the color image is residual transformed and a macroblock estimation mode and is the same as the redundancy remover 130 shown in FIG. 1. The quantizer 740 quantizes the frequency domain image from which the redundancy has been removed and is the same as the quantizer 160 shown in FIG. 1. The entropy encoder 750 entropy-encodes the quantized data.

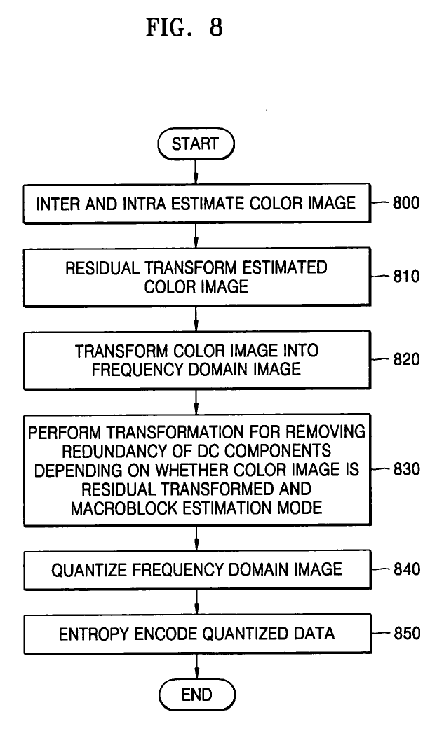

FIG. 8 is a flowchart of a method of encoding a color image using the method of transforming and quantizing the color image according to an embodiment of the present invention. The method of encoding the color image will be described with reference to FIGS. 7 and 8. In operation 800, the temporal and spatial estimator 700 receives and temporally (inter) and spatially (intra) estimates a color image. In operation 810, the residual transformer 710 residual transforms the estimated color image. In operation 820, the domain transformer 720 transforms the color image into a frequency domain image. In operation 830, the redundancy remover 730 differently applies a transformation for removing a redundancy of DC components of the frequency domain image depending on whether the color image is residual transformed and a macroblock estimation mode. In operation 840, the quantizer 740 quantizes the frequency domain image from which the redundancy has been removed. In operation 850, the entropy encoder 750 entropy-encodes the quantized data. Operations 820, 830, and 840 are the same as those of the method of transforming and quantizing the color image, and thus their detailed description will be omitted.

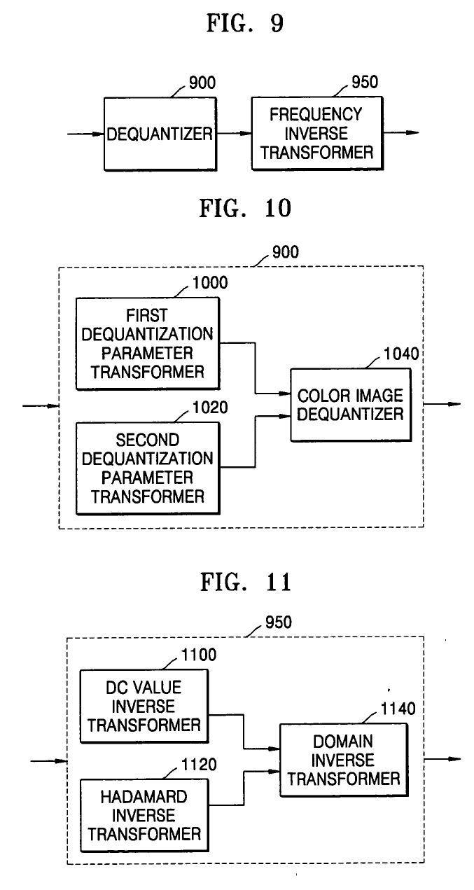

An apparatus and a method for dequantizing and inverse transforming a color image according to an embodiment of the present invention will now be described. FIG. 9 is a block diagram of an apparatus for dequantizing and inverse transforming a color image according to an embodiment of the present invention. Referring to FIG. 9, the apparatus includes a dequantizer 900 and a frequency inverse transformer 950.

The dequantizer 900 differently sets a quantization parameter of a chrominance component depending on whether quantized color image data is residual transformed to dequantize the quantized color image data. FIG. 10 is a block diagram of the dequantizer 900 shown in FIG. 9. Referring to FIG. 10, the dequantizer 900 includes a first dequantization parameter transformer 1000, a second dequantization parameter transformer 1020, and a color image dequantizer 1040. If information residual_colour_transform_flag as to whether a residual transformation is performed indicates a performance of the residual transformation residual_colour_transform_flag=1, the first dequantization parameter transformer 1000 represents the quantization parameter of the chrominance as in Equation 3 above. If the information residual_colour_transform_flag indicates a non-performance of the residual transformation residual_colour_transform_flag=0, the second dequantization parameter transformer 1020 represents the quantization parameter of the chrominance as in Equation 4 above. The color image dequantizer 1040 dequantizes the transformed color image data using the QP′c.

The inverse transformer 950 differently performs a recovery of a redundancy of DC components of the color image depending on whether the dequantized data is residual transformed and a macroblock estimation mode to frequency inverse transform the dequantized data. FIG. 11 is a block diagram of the inverse transformer 950 shown in FIG. 10. Referring to FIG. 11, the inverse transformer 950 includes a DC value inverse transformer 1100, a Hadamard inverse transformer 1120, and a domain inverse transformer 1140. If information residual_colour_transform_flag as to whether a residual transformation is performed indicates a performance of the residual transformation residual_colour_transform_flag=1 and a macroblock estimation mode with respect to luma (Y or G component) is a 4×4 intra estimation mode Intra_{—}4×4 or a 8×8 intra estimation mode Intra_{—}8×8, the DC value inverse transformer 1100 quadruplicates a transformed 4×4 DC value matrix obtained from entropy decoded color image data as in Equation 1 above.

If the information residual_colour_transform_flag indicates a non-performance of the residual transformation residual_colour_transform_flag=0 or the macroblock estimation mode with respect to the luma (Y or G component) is not both the 4×4 intra estimation mode Intra_{—}4×4 and the 8×8 intra estimation mode Intra_{—}8×8, the Hadamard inverse transformer 1120 Hadamard inverse transforms the transformed 4×4 DC value matrix.

The domain inverse transformer 1140 frequency inverse transforms the result value of the DV value inverse transformer 1100 or the Hadamard inverse transformer 1120 and an alternating current (AC) value recovered from the entropy decoded color image data. The frequency inverse transformation may be integer inverse transformation in H.264 but IDCT in MPEG.

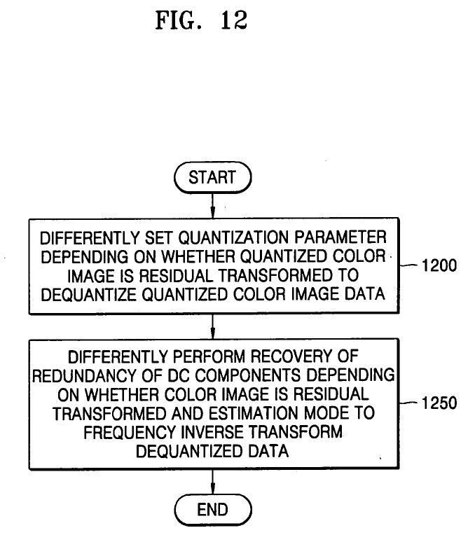

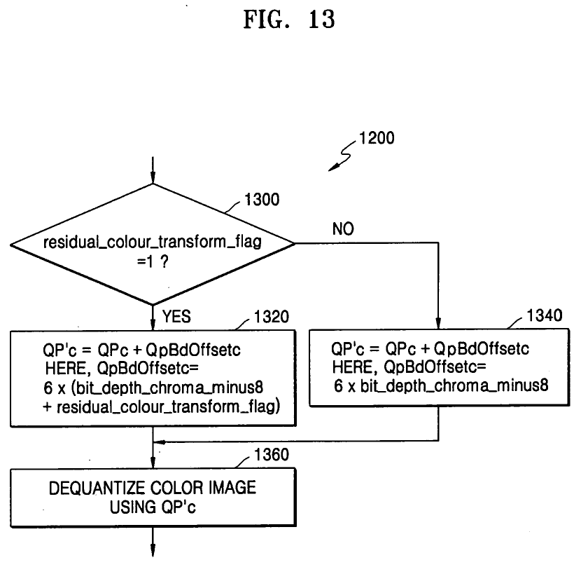

FIG. 12 is a flowchart of a method of dequantizing and inverse transforming a color image according to an embodiment of the present invention. A method and an apparatus for dequantizing and inverse transforming a color image will now be described with reference to FIGS. 11 and 12.

If quantized color image data is input to the dequantizer 900, the dequantizer 900 differently sets a quantization parameter of a chrominance component depending on whether the quantized color image data is residual transformed to dequantize the quantized color image data in operation 1200.

In operation 1250, the frequency inverse transformer 950 differently performs a recovery of a redundancy of DC components of the color image depending on whether the color image is residual transformed and an estimation mode to frequency inverse transform the dequantized data.

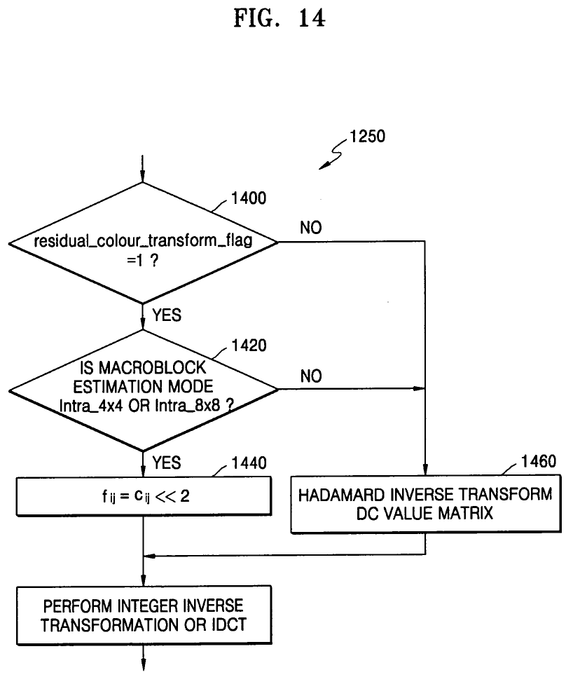

FIG. 13 is a flowchart of operation 100 of the method of FIG. 12. If information residual_colour_transform_flag as to whether a residual transformation is performed indicates a performance of the residual transformation residual_colour_transform_flag=1 in operation 1300, the first dequantization parameter transformer 1000 represents a quantization parameter of a chrominance component as in Equation 3 above in operation 1320. If the information residual_colour_transform_flag indicates a non-performance of the residual transformation residual_colour_transform_flag=0 in operation 1300, the second dequantization parameter transformer 1020 represents the quantization parameter of the chrominance component as in Equation 4 above in operation 1340. In operation 1360, the color image dequantizer 1040 dequantizes the transformed color image data using the QP′c.

FIG. 14 is a flowchart of operation 1250 of the method of FIG. 12. If the information residual_colour_transform_flag indicates the performance of the residual transformation residual_colour_transform_flag=1 in operation 1400 and a macroblock estimation mode with respect to luma (Y or G component) is a 4×4 intra estimation mode Intra_{—}4×4 or a 8×8 intra estimation mode Intra_{—}8×8 in operation 1420, the DC value inverse transformer 1100 quadruplicates a transformed 4×4 DC value matrix obtained from entropy decoded color image data as in Equation 1 above in operation 1440. If the information residual_colour_transform_flag indicates the non-performance of the residual transformation residual_colour_transform_flag=0 in operation 1400 or the macroblock estimation mode with respect to the luma (Y or G component) is not both the 4×4 intra estimation mode Intra_{—}4×4 and the 8×8 intra estimation mode Intra_{—}8×8 in operation 1420, the Hadamard inverse transformer 1120 Hadamard inverse transforms the transformed 4×4 DC value matrix in operation 1460. In operation 1480, the domain inverse transformer 1140 frequency inverse transforms the result value of operation 1440 or 1460 and an AC value recovered from the entropy decoded color image data. The frequency inverse transformation may be integer inverse transformation in H.264 or IDCT in MPEG.

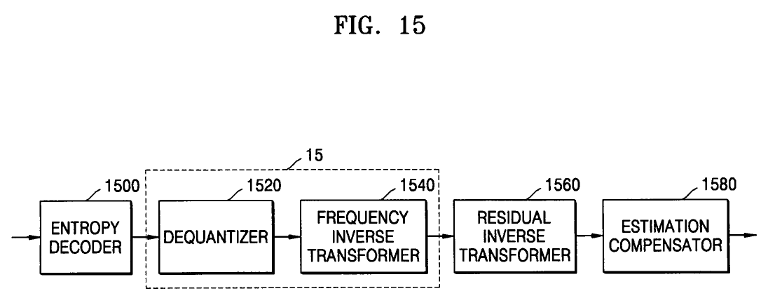

An apparatus and a method for decoding a color image using the apparatus for dequantizing and inverse transforming the color image will now be described. FIG. 15 is a block diagram of an apparatus for decoding a color image using the apparatus for dequantizing and inverse transforming the color image according to an embodiment of the present invention. Referring to FIG. 15, the apparatus includes an entropy decoder 1500, a dequantizer and inverse transformer 15, a residual inverse transformer 1560, and an estimation compensator 1580.

The entropy decoder 1500 entropy decodes encoded color image data to recover quantized data.

The dequantizer and inverse transformer 15 is the same as the apparatus for dequantizing and inverse transforming the color image and includes a dequantizer 1520 and a frequency inverse transformer 1540. The dequantizer 1520 differently sets a quantization parameter of a chrominance component depending on whether the quantization data is residual transformed to dequqntize the quantized data. The dequantizer 1520 is also the same as the dequantizer 900 shown in FIG. 9, and thus its detailed description will be omitted. The frequency inverse transformer 1540 differently performs a recovery of a redundancy of DC components of a color image depending on whether the color image is residual transformed and a macroblock estimation mode to frequency inverse transform the dequantized data. The frequency inverse transformer 1540 is also the same as the frequency inverse transformer 950 shown in FIG. 9, and thus its detailed description will be omitted.

The residual inverse transformer 1560 residual inverse transforms the frequency inverse transformed data. The estimation compensator 1580 performs intra and inter estimation compensations with respect to the residual inverse transformed data.

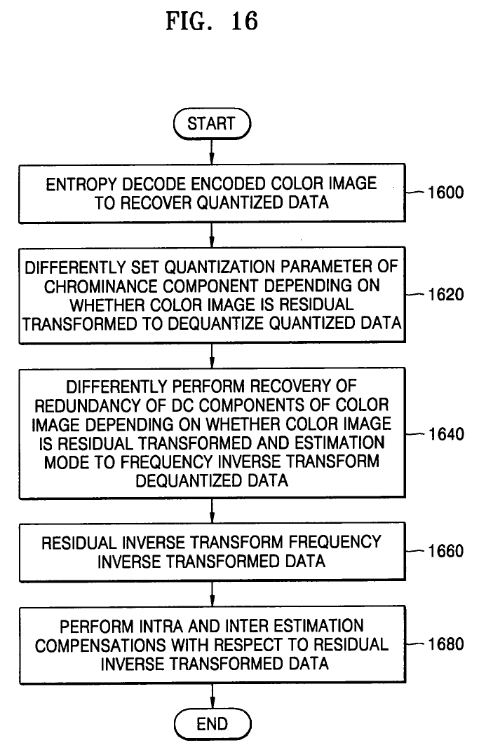

FIG. 16 is a flowchart of a method of decoding a color image using the method of dequantizing and inverse transforming the color image according to an embodiment of the present invention.

If encoded color image data is input to the entropy decoder 1500, in operation 1600, the entropy decoder 1500 entropy decodes the encoded color image data to recover quantized data. In operation 1620, the dequantizer 152 differently sets a quantization parameter of a chrominance component depending on whether a color image is residual transformed to dequantize the quantized data. In operation 1640, the frequency inverse transformer 1540 differently performs a recovery of a redundancy of DC components of the color image depending on whether the color image is residual transformed and an estimation mode to frequency inverse transform the dequantized data. In operation 1660, the residual inverse transformer 1560 residual inverse transforms the frequency inverse transformed data. In operation 1680, the estimation compensator 1580 performs intra and inter estimation compensations with respect to the residual inverse transformed data.

Operations 1620 and 1640 are the same as those of the method of dequantizing and inverse transforming the color image shown in FIG. 12, and thus their detailed description will be omitted.

In a method and an apparatus for quantizing/dequantizing and transforming/inverse transforming a color image and a method and an apparatus for encoding/decoding a color image using the method and the apparatus according to the above-described embodiments of the present invention, a residual transformation can be applied regardless of an inter or intra estimation mode. Thus, compression efficiency can be improved. Also, a quantization appropriate for the residual transformation can be performed. As a result, compression efficiency can be improved.

The present invention can also be embodied as computer readable codes on a computer-readable storage medium. A computer-readable storage medium is any data storage device that can store data which can be thereafter read by a computer system. Examples include read-only memory (ROM), random-access memory (RAM), CD-ROMs, magnetic tapes, floppy disks, optical data storage devices, and the like.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of transforming and quantizing a color image, comprising:
transforming a color image into a frequency domain image;
differently applying a transformation for removing a redundancy of direct current components of the frequency domain image depending on whether the color image is residual transformed and a macroblock estimation mode; and
quantizing the frequency domain image from which the redundancy has been removed.

2. The method of claim 1, wherein the differently applying the transformation comprises:
when information as to whether a residual transformation is performed indicates a performance of the residual transformation and the macroblock estimation mode with respect to luma (Y or G component) is a 4×4 intra estimation mode or a 8×8 intra estimation mode, quadruplicating a 4×4 direct current value matrix obtained from the result of the frequency transformation using an Equation
fᵢⱼ=cᵢⱼ<<2 (where, i,j=0 . . . 3); and
when the information indicates a non-performance of the residual transformation or the macroblock estimation mode with respect to the luma (Y or G component) is not the 4×4 intra estimation mode and the 8×8 intra estimation mode, Hadamard-transforming the 4×4 direct current value matrix.

3. The method of claim 2, wherein the quantizing the frequency domain image comprises:
when the information indicates the performance of the residual transformation, representing a quantization parameter of a chrominance component by an Equation
QP′c=QPc+QpBdOffsetc
in which QpBdOffsetc=6*(bit_depth_chroma_minus8+residual_colour_transform_flag), QPc denotes a quantization parameter of a chrominance component Cb, Cr, R, or B, and QpBdOffsetc denotes offset of QPc and bit_depth_chroma_minus8 denotes a bit depth of a chrominance array sample per pixel;
when the information indicates the non-performance of the residual transformation, representing the quantization parameter of the chrominance component by the Equation
QP′c=QPc+QpBdOffsetc
in which QpBdOffsetc=6*bit depth_chroma_minus8; and
quantizing the transformed color image data using the QP′c.

4. An apparatus for transforming and quantizing a color image, comprising:
a domain transformer transforming a color image into a frequency domain image;
a redundancy remover differently applying a transformation for removing a redundancy of direct current components of the frequency domain image depending on whether the color image is residual transformed and a macroblock estimation mode; and
a quantizer quantizing the frequency domain image from which the redundancy has been removed.

5. The apparatus of claim 4, wherein the redundancy remover comprises:
a direct current value transformer quadruplicating a 4×4 direct current value matrix obtained from the result of the frequency transformation using an Equation
fᵢⱼ=cᵢⱼ<<2 (where, i,j=0 . . . 3),
when information as to whether a residual transformation is performed indicates a performance of the residual transformation and the macroblock estimation mode with respect to luma (Y or G component) is a 4×4 intra estimation mode or a 8×8 intra estimation mode; and
a Hadamard transformer Hadamard-transforming the 4×4 direct current value matrix, when the information indicates a non-performance of the residual transformation or the macroblock estimation mode with respect to the luma (Y or G component) is not both the 4×4 intra estimation mode and the 8×8 intra estimation mode.

6. The apparatus of claim 5, wherein the quantizer comprises:
a first quantization parameter transformer representing a quantization parameter of a chrominance component by an Equation
QP′c=QPc+QpBdOffsetc
in which QpBdOffsetc=6*(bit_depth_chroma_minus8+residual_colour_transform_flag), QPc denotes a quantization parameter of a chrominance component Cb, Cr, R, or B, and QpBdOffsetc denotes offset of QPc and bit_depth_chroma_minus8 denotes a bit depth of a chrominance array sample per pixel, when the information indicates the performance of the residual transformation;
a second quantization parameter transformer representing the quantization parameter of the chrominance component by an Equation
QP′c=QPc+QpBdOffsetc
in which QpBdOffsetc=6*bit_depth_chroma_minus8, when the information indicates the non-performance of the residual transformation; and
a color image quantizer quantizing the transformed color image data using the QP′c.

7. A method of encoding a color image, comprising:
temporally (inter estimating) and spatially (intra estimating) an input color image;
residual transforming the estimated color image;
transforming the color image into a frequency domain image;
differently applying a transformation for removing a redundancy of direct current components of the frequency domain image depending on whether the color image is residual transformed and an estimation mode;
quantizing the frequency domain image from which the redundancy has been removed; and
entropy encoding the quantized data.

8. The method of claim 7, wherein the differently applying the transformation comprises:
when information as to whether a residual transformation is performed indicates a performance of the residual transformation and the macroblock estimation mode with respect to luma (Y or G component) is a 4×4 intra estimation mode or a 8×8 intra estimation mode, quadruplicating a 4×4 direct current value matrix obtained from the result of the frequency transformation by an Equation
fᵢⱼ=cᵢⱼ<<2 (where, i,j=0 . . . 3); and
when the information indicates a non-performance of the residual transformation or the macroblock estimation mode with respect to the luma (Y or G component) is not both the 4×4 intra estimation mode and the 8×8 intra estimation mode, Hadamard-transforming the 4×4 direct current value matrix.

9. The method of claim 8, wherein quantizing the frequency domain image from which the redundancy has been removed comprises:
when the information indicates the performance of the residual transformation, representing a quantization parameter of a chrominance component by the following Equation
QP′c=QPc+QpBdOffsetc,
in which QpBdOffsetc=6*(bit_depth_chroma_minus8+residual_colour_transform_flag) and QPc denotes a quantization parameter of a chrominance component Cb, Cr, R, or B, where QpBdOffsetc denotes offset of QPc and bit_depth_chroma_minus8 denotes a bit depth of a chrominance array sample per pixel;
when the information indicates the non-performance of the residual transformation, representing the quantization parameter of the chrominance component by the Equation
QP′c=QPc+QpBdOffsetc,
in which QpBdOffsetc=6*bit_depth_chroma_minus8; and
quantizing the transformed color image data using the QP′c.

10. An apparatus for encoding a color image, comprising:
an estimator temporally (inter estimating) and spatially (intra estimating) an input color image;
a residual transformer residual transforming the estimated color image;
a domain transformer transforming the color image into a frequency domain image;
a redundancy remover differently applying a transformation for removing a redundancy of direct current components of the frequency domain image depending on whether the color image is residual transformed and a macroblock estimation mode;
a quantizer quantizing the frequency domain image from which the redundancy has been removed; and
an entropy encoder entropy encoding the quantized data.

11. The apparatus of claim 10, wherein the redundancy remover comprises:
a direct current value transformer quadruplicating a 4×4 direct current value matrix obtained from the result of the frequency transformation by an Equation
fᵢⱼ=cᵢⱼ<<2 (where, i,j=0 . . . 3)
when information as to whether a residual transformation is performed indicates a performance of the residual transformation and the macroblock estimation mode with respect to luma (Y or G component) is a 4×4 intra estimation mode or a 8×8 intra estimation mode; and
a Hadamard transformer Hadamard-transforming the 4×4 direct current value matrix, when the information indicates a non-performance of the residual transformation or the macroblock estimation mode with respect to the luma (Y or G component) is not both the 4×4 intra estimation mode and the 8×8 intra estimation mode.

12. The apparatus of claim 11, wherein the quantizer comprises:
a first quantization parameter transformer representing a quantization parameter of a chrominance component by an Equation
QP′c=QPc+QpBdOffsetc,
in which QpBdOffsetc=6*(bit_depth_chroma_minus8+residual_colour_transform_flag) and QPc denotes a quantization parameter of a chrominance component Cb, Cr, R, or B, where QpBdOffsetc denotes offset of QPc and bit_depth_chroma_minus8 denotes a bit depth of a chrominance array sample per pixel, when the information indicates the performance of the residual transformation;
a second quantization parameter transformer representing the quantization parameter of the chrominance component by the Equation
QP′c=QPc+QpBdOffsetc
in which QpBdOffsetc=6*bit_depth_chroma_minus8, when the information indicates the non-performance of the residual transformation; and
a color image quantizer quantizing the transformed color image data using the QP′c.

13. A method of dequantizing and inverse transforming a color image, comprising:
differently setting a quantization parameter of a chrominance component depending on whether the color image is residual transformed to dequantize the quantized color image data; and
differently performing a recovery of a redundancy of direct current components of the color image depending on whether the color image is residual transformed and an estimation mode to frequency inverse transform the dequantized data.

14. The method of claim 13, wherein dequantizing the quantized color image comprises:
when information as to whether a residual transformation is performed indicates a performance of the residual transformation, representing a quantization parameter of a chrominance component by an Equation
QP′c=QPc+QpBdOffsetc
in which QpBdOffsetc=6*(bit_depth_chroma_minus8+residual_colour_transform_flag), QPc denotes a quantization parameter of a chrominance component Cb, Cr, R, or B, and QpBdOffsetc denotes offset of QPc and bit_depth_chroma_minus8 denotes a bit depth of a chrominance array sample per pixel;
when the information indicates a non-performance of the residual transformation, representing the quantization parameter of the chrominance component by the Equation
QP′c=QPc+QpBdOffsetc
in which QpBdOffsetc=6*bit_depth_chroma_minus8; and
dequantizing the transformed color image data using the QP′c.

15. The method of claim 14, wherein the frequency inverse transforming the dequantized data comprises:
when the information indicates the performance of the residual transformation and a macroblock estimation mode with respect to luma (Y or G component) is a 4×4 intra estimation mode or a 8×8 intra estimation mode, quadruplicating a transformed 4×4 direct current value matrix obtained from entropy decoded color image data by an Equation
fᵢⱼ=cᵢⱼ<<2 (where, i,j=0 . . . 3);
when the information indicates the non-performance of the residual transformation or the macroblock estimation mode with respect to the luma (Y or G component) is not both the 4×4 intra estimation mode and the 8×8 intra estimation mode, Hadamard inverse transforming the transformed 4×4 direct current value matrix; and
frequency inverse transforming the result value of the quadruplication or the Hadamard inverse transformation and an alternating current value recovered from the entropy decoded color image.

16. The method of claim 15, wherein the frequency transformation is an integer inverse transformation of H.264 or an IDCT of MPEG.

17. An apparatus for dequantizing and inverse transforming a color image, comprising:
a dequantizer differently setting a quantization parameter of a chrominance component depending on whether quantized color image data is residual transformed to dequantize the quantized color image data; and
a frequency inverse transformer differently performing a recovery of a redundancy of direct current components of a color image depending on whether the color image is residual transformed and an estimation mode to frequency inverse transform the dequantized data.

18. The apparatus of claim 17, wherein the dequantizer comprises:
a first dequantization parameter transformer representing a quantization parameter of a chrominance component using an Equation
QP′c=QPc+QpBdOffsetc
in which QpBdOffsetc=6*(bit_depth_chroma_minus8+residual_colour_transform_flag), QPc denotes a quantization parameter of a chrominance component Cb, Cr, R, or B, and QpBdOffsetc denotes offset of QPc and bit_depth_chroma_minus8 denotes a bit depth of a chrominance array sample per pixel, when information as to whether a residual transformation is performed indicates a performance of the residual transformation;
a second dequantization parameter transformer representing the quantization parameter of the chrominance component by the Equation
QP′c=QPc+QpBdOffsetc
in which QpBdOffsetc=6*bit_depth_chroma_minus8, when the information indicates a non-performance of the residual transformation; and
a color image dequantizer dequantizing the transformed color image data using the QP′c.

19. The apparatus of claim 18, wherein the frequency inverse transformer comprises:
a direct current value inverse transformer quadruplicating a transformed 4×4 direct current value matrix obtained from entropy decoded color image by an Equation
fᵢⱼ=cᵢⱼ<<2 (where, i,j=0 . . . 3)
when the information indicates the performance of the residual transformation and a macroblock estimation mode with respect to luma (Y or G component) is a 4×4 intra estimation mode or a 8×8 intra estimation mode;
a Hadamard inverse transformer Hadamard inverse transforming the transformed 4×4 direct current value matrix, when the information indicates the non-performance of the residual transformation or the macroblock estimation mode with respect to the luma (Y or G component) is not both the 4×4 intra estimation mode and the 8×8 intra estimation mode; and
a domain inverse transformer frequency inverse transforming the result value of the direct current value inverse transformer or the Hadamard inverse transformer and an alternating current value recovered from the entropy decoded color image.

20. The apparatus of claim 19, wherein the frequency inverse transformation performed by the domain inverse transformer is an integer inverse transformation of H.264 or an IDCT of MPEG.

21. A method of decoding a color image, comprising:
entropy decoding encoded color image data to recover quantized data;
differently setting a quantization parameter of a chrominance component depending on whether the color image is residual transformed to dequantize the quantized data;
differently performing a recovery of a redundancy of direct current components of the color image depending on whether the color image is residual transformed and an estimation mode to frequency inverse transform the dequantized data;
residual inverse transforming the frequency inverse transformed data; and
performing intra and inter estimation compensations with respect to the residual inverse transformed data.

22. The method of claim 21, wherein the dequantizing the quantized data comprises:
when information as to whether a residual transformation is performed indicates a performance of the residual transformation, representing a quantization parameter of a chrominance component by an Equation
QP′c=QPc+QpBdOffsetc
in which QpBdOffsetc=6*(bit_depth_chroma_minus8+residual_colour_transform_flag), QPc denotes a quantization parameter of a chrominance component Cb, Cr, R, or B, and QpBdOffsetc denotes offset of QPc and bit_depth_chroma_minus8 denotes a bit depth of a chrominance array sample per pixel;
when the information indicates a non-performance of the residual transformation, representing the quantization parameter of the chrominance component by an Equation
QP′c=QPc+QpBdOffsetc
in which QpBdOffsetc=6*bit_depth_chroma_minus8; and
dequantizing the transformed color image data using the QP′c.

23. The method of claim 22, wherein the frequency inverse transforming the dequantized data comprises:
when the information indicates the performance of the residual transformation and a macroblock estimation mode with respect to luma (Y or G component) is a 4×4 intra estimation mode or a 8×8 intra estimation mode, quadruplicating a transformed 4×4 direct current value matrix obtained from entropy decoded color image data by an Equation
fᵢⱼ=cᵢⱼ<<2 (where, i,j=0 . . . 3);
when the information indicates the non-performance of the residual transformation or the macroblock estimation mode with respect to the luma (Y or G component) is not both the 4×4 intra estimation mode and the 8×8 intra estimation mode, Hadamard inverse transforming the transformed 4×4 direct current value matrix; and
frequency inverse transforming the result value of the quadruplication or the Hadamard inverse transformation and an alternating current value recovered from the entropy decoded color image data.

24. The method of claim 23, wherein the frequency inverse transformation is an integer inverse transformation of H.264 or an IDCT of MPEG.

25. An apparatus for decoding a color image, comprising:
an entropy decoder entropy decoding encoded color image data to recover quantized data;
a dequantizer differently setting a quantization parameter of a chrominance component depending on whether the color image is residual transformed to dequantize the quantized data;
a frequency inverse transformer differently performing a recovery of a redundancy of direct current components of the color image depending on whether the color image is residual transformed and a macroblock estimation mode to frequency inverse transform the dequantized data;
a residual inverse transformer residual inverse transforming the frequency inverse transformed data; and
an estimation compensator performing intra and inter estimation compensations with respect to the residual inverse transformed data.

26. The apparatus of claim 25, wherein the dequantizer comprises:
a first dequantization parameter transformer representing a quantization parameter of a chrominance component by an Equation
QP′c=QPc+QpBdOffsetc
in which QpBdOffsetc=6*(bit_depth_chroma_minus8+residual_colour_transform_flag), QPc denotes a quantization parameter of a chrominance component Cb, Cr, R, or B, and QpBdOffsetc denotes offset of QPc and bit_depth_chroma_minus8 denotes a bit depth of a chrominance array sample per pixel, when information as to whether a residual transformation is performed indicates a performance of the residual transformation;
a second dequantization parameter transformer representing the quantization parameter of the chrominance component by an Equation
QP′c=QPc+QpBdOffsetc
in which QpBdOffsetc=6*bit_depth_chroma_minus8, when the information indicates a non-performance of the residual transformation; and
a color image dequantizer dequantizing the transformed color image data using the QP′c.

27. The apparatus of claim 26, wherein the frequency inverse transformer comprises:
a direct current value inverse transformer quadruplicating a transformed 4×4 direct current value matrix obtained from entropy decoded color image data by an Equation
fᵢⱼ=cᵢⱼ<<2 (where, i,j=0 . . . 3)
when the information indicates the performance of the residual transformation and a macroblock estimation mode with respect to luma (Y or G component) is a 4×4 intra estimation mode or a 8×8 intra estimation mode;
a Hadamard inverse transformer Hadamard inverse transforming the transformed 4×4 direct current value matrix, when the information indicates the non-performance of the residual transformation or the macroblock estimation mode with respect to the luma (Y or G component) is not both the 4×4 intra estimation mode and the 8×8 intra estimation mode; and
a domain inverse transformer frequency inverse transforming the result value of the direct current value inverse transformer or the Hadamard inverse transformer and an alternating current value recovered from the entropy decoded color image data.

28. The apparatus of claim 27, wherein the frequency inverse transformation performed by the domain inverse transformer is an integer inverse transformation of H.264 or an IDCT of MPEG.

29. A computer-readable storage medium encoded with processing instructions for causing a processor to perform a method of transforming and quantizing a color image, the method comprising:
transforming a color image into a frequency domain image;
differently applying a transformation for removing a redundancy of direct current components of the frequency domain image depending on whether the color image is residual transformed and a macroblock estimation mode; and
quantizing the frequency domain image from which the redundancy has been removed.

30. A computer-readable storage medium encoded with processing instructions for causing a processor to perform a method of encoding a color image, the method comprising:
temporally (inter estimating) and spatially (intra estimating) an input color image;
residual transforming the estimated color image;
transforming the color image into a frequency domain image;
differently applying a transformation for removing a redundancy of direct current components of the frequency domain image depending on whether the color image is residual transformed and an estimation mode;
quantizing the frequency domain image from which the redundancy has been removed; and
entropy encoding the quantized data.

31. A computer-readable storage medium encoded with processing instructions for causing a processor to perform a method of dequantizing and inverse transforming a color image, the method comprising:
differently setting a quantization parameter of a chrominance component depending on whether the color image is residual transformed to dequantize the quantized color image data; and
differently performing a recovery of a redundancy of direct current components of the color image depending on whether the color image is residual transformed and an estimation mode to frequency inverse transform the dequantized data.

32. A computer-readable storage medium encoded with processing instructions for causing a processor to perform a method of decoding a color image, the method comprising:
entropy decoding encoded color image data to recover quantized data;
differently setting a quantization parameter of a chrominance component depending on whether the color image is residual transformed to dequantize the quantized data;
differently performing a recovery of a redundancy of direct current components of the color image depending on whether the color image is residual transformed and an estimation mode to frequency inverse transform the dequantized data;
residual inverse transforming the frequency inverse transformed data; and
performing intra and inter estimation compensations with respect to the residual inverse transformed data.
